(19) United States
(12) Patent Application Publication
(10) Pub. No.: US 2018/0250779 A1
(43) Pub. Date: Sep. 6, 2018

(54) METHOD FOR PRODUCING A HEAT EXCHANGER

(71) Applicant: Mahle International GmbH, Stuttgart (DE)

(72) Inventors: Carolin Sailer, Ammerbuch (DE); Thomas Schiehlen, Altheim (DE); Dominique Weinmann, Rottenburg (DE)

(21) Appl. No.: 15/759,207

(22) PCT Filed: Sep. 6, 2016
(86) PCT No.: PCT/EP2016/070918

§ 371 Date: Mar. 9, 2018

(30) Foreign Application Priority Data
Sep. 11, 2015 (DE) 10 2015 217 470.0

(51) Int. Cl. B23P 15/26; B21D 53/06

(52) U.S. Cl. CPC B23P 15/26; B21D 53/06

(57) ABSTRACT

A method for producing a heat exchanger may include adhesively bonding at least two components to one another and applying an adhesive layer to an outer side of at least one of the at least two components.

### CROSS-REFERENCE TO RELATED APPLICATIONS

This application claims priority to International Patent Application No. PCT/EP2016/070918, filed on Sep. 6, 2016, and German Patent Application No. DE 10 2015 217 470.0, filed on Sep. 11, 2015, the contents of each of which are hereby incorporated by reference in their entirety.

### TECHNICAL FIELD

The present invention relates to a method for producing a heat exchanger having at least two components, which are adhesively bonded to one another.

### BACKGROUND

Cooling modules for the use of refrigerants and the use of coolants, the manufacture of which commonly involves materials suitable for brazing, e.g. stainless steel, copper or aluminum, have already been manufactured for decades. These materials are coated with brazing alloy as semifinished products. The plating of brazing alloy on the semifinished products comprises a layer of material which has a lower melting point than the base material. For brazing, the parts are clamped and then brazed in a furnace at a temperature which comes close to the melting point of the base material. Among the requirements for this purpose are, for example, fluxes which break up or dissolve the external oxide layer. However, fluxes have the disadvantage that they are harmful to health; moreover, residues may remain on the components, and these have a negative effect on the required cleanliness of the component. Furthermore, brazing only makes sense for joining materials of the same type in order, for example, to accommodate thermal elongation or even to prevent this from occurring at all. From a corrosion point of view, there should likewise be no potential differences between varying materials. Brazing can then take place successfully if various boundary conditions are maintained, as follows: degreasing of the parts (currently with PER), stacking and clamping of the semifinished products plated with brazing alloy, brazing in the furnace at around 650° C. for several hours, leak testing of the parts and, where applicable, re-brazing if the parts are not leaktight. However, this process is very time-consuming, expensive and resource-intensive, which has a negative effect on the CO₂ balance.

When joining two joining partners composed of different materials, different thermal expansions must be taken into account and compensated, something that a brazed joint can ensure to only a limited extent or with only a certain fatigue strength.

As an alternative to brazing, there is also the possibility, purely in theory, of adhesively bonding the individual components of the heat exchanger, although this has hitherto failed owing to a lack of methods of appropriate process reliability. Moreover, it was not possible to configure the bubble-free and high-quality application of an adhesive layer in a reliable process with correspondingly sufficient flexibility to enable it to be adapted easily to different requirements.

### SUMMARY

The present invention is therefore concerned with the problem of specifying alternative embodiments to a method of the type in question which all allow application of an adhesive layer in a reliable and simultaneously economical process to a heat exchanger component to be adhesively bonded.

According to the invention, this problem is solved by the subject matter of the independent claim(s). Advantageous embodiments form the subject matter of the dependent claim(s).

The present invention is based on the general concept of specifying different and alternatively applicable methods for the application of an adhesive layer to a heat exchanger component to be adhesively bonded, wherein the component to be coated with the adhesive layer can be narrow stock or a tube, for example, wherein, as the process progresses, it is possible, for example, for tubes to be formed or corrugated fins to be embossed or stamped from the narrow stock.

In an advantageous development of the solution according to the invention, the heat exchanger component to be coated is designed as narrow stock and the adhesive layer is designed as an adhesive film, wherein, for production, a surface of the narrow stock to be coated with the adhesive layer is advantageously first of all degreased and/or brushed. The adhesive film is then heated and applied to the narrow stock to be coated, wherein the adhesive film and the narrow stock to be coated are passed through pressure rollers and, during this process, pressed against one another. After this, the narrow stock coated in this way, i.e. the component, is cooled and rolled up. The advantage of such coating of the narrow stock with an adhesive layer or an adhesive film is the fact that both the narrow stock and the adhesive film are in the form of rolls and are therefore easy to process and easy to store. In this embodiment, it is furthermore possible to provide a continuous coating process, which furthermore prevents a nonuniform thickness of the adhesive layer to be applied by means of the adhesive film. Purely theoretically, it is, of course, also possible to heat the narrow stock in order to apply the adhesive film.

In an alternative development of the method according to the invention, the component to be coated is designed as a tube and the adhesive layer is designed as an adhesive film. In this method, a surface of the tube to be coated with the adhesive layer is likewise preferably first of all degreased and brushed, and the adhesive film and the tube to be coated are then passed through pressure rollers and pressed against one another. The adhesive film and the tube to be coated are then passed through a furnace and, during this process, heated, wherein the adhesive film is shrunk onto the tube to be coated. Here, shrinking can take place directly after the extrusion of the tube, for example, or, alternatively, can be performed on tubes that have already been cut to length. In this case, it is possible—as described—for heating of the adhesive film to take place in the furnace following on from the pressure rollers and/or to be accomplished by means of an internally heated tube, for which purpose a hot fluid flow is passed through the tube, for example. In this method too, the adhesive layer can be applied to the tube to be coated in a simple and continuous process as an adhesive film, and is therefore easy to process and easy to store. If the freshly extruded tube is coated, for example, the heat of the tube originating from the extrusion of the tube can be used to heat the adhesive layer during this process, and an additional cleaning step is eliminated.

In an advantageous development of the method according to the invention described above, it is also possible for at least two pressure rollers to be provided, wherein, for example, at least one of the pressure rollers is heated and thereby brings about the heating of the adhesive layer designed as an adhesive film. In order to allow application of the adhesive layer or adhesive film to the narrow stock or the tube as far as possible without bubbles, at least one pressure roller can have a contour matched to the external contour of the component to be coated, with the result that, when the component is configured as a tube, the associated roller has a convex corresponding groove, for example. If the component to be coated is designed as narrow stock, for example, the pressure roller has the configuration of a cylinder in this case. Of course, it is also conceivable for at least two pressure roller pairs arranged in series to be provided, each of which ensures that the adhesive film is correspondingly pressed into contact in a corresponding region of the tube. By this means too, the risk of defects and the risk of nonuniform thickness of the adhesive layer, for example, can be considerably reduced. The risk of defects due to deviations in the dimensions of the tube, for example, can furthermore be minimized by a spring action on the pressure rollers. A relatively flexible production process is also possible by this means since the sprung pressure rollers allow the processing or coating of different tube geometries with a corresponding associated adhesive layer.

In another advantageous and alternative embodiment of the method according to the invention, the component to be coated is designed as narrow stock and the adhesive layer is designed as an initially liquid adhesive, wherein, in this case, a surface of the narrow stock to be coated with the adhesive layer is likewise advantageously first of all degreased and brushed and thereby cleaned and prepared. The initially liquid adhesive is then applied by means of an application roller to the narrow stock to be coated, and the narrow stock coated with the applied adhesive layer is then cooled. In this case, the adhesive to be processed can be supplied as granules and melted and then processed directly, for example. In this method, the risk of defects due to deviations in the dimensions of the tubes can be reduced, especially inasmuch as the application roller is spring-mounted for example.

In another alternative embodiment of the method according to the invention, the component to be coated is designed as narrow stock and the adhesive layer is designed initially as granules, wherein, in this alternative method for applying the adhesive layer too, a surface of the narrow stock to be coated with the adhesive layer is advantageously first of all degreased and brushed. The narrow stock to be coated is then heated and the granules are then scattered onto said narrow stock, melting to form the adhesive layer. The narrow stock with the adhesive layer applied thereto is then passed through pressure rollers and, during this process, the adhesive layer is rendered uniform and simultaneously joined to the narrow stock. The coated narrow stock can then be rolled up and prepared or stored for a further processing step, e.g. for the forming of tubes or the formation or stamping of corrugated fins.

In another alternative embodiment of the method according to the invention, the component to be coated is designed as a tube and the adhesive layer is designed initially as granules. It is expedient if, after degreasing and/or brushing of the surface of the tube, the tube to be coated is then heated and the granules are scattered onto the tube to be coated. The tube with the adhesive layer applied thereto is then passed through pressure rollers and, during this process, the adhesive layer is rendered uniform and joined to the tube, whereupon the coated tube is cooled. By this means too, there is the possibility, on the one hand, of applying the adhesive layer in an extremely reliable process, and, on the other hand, of doing so with the greatest possible flexibility.

In an advantageous development of all the alternatives of the method according to the invention, application of the adhesive layer is followed by an optical check. During an optical check of this kind, which can be carried out in an automated manner with appropriate detection software for example, defects can be detected during the manufacturing process and can, for example, still be eliminated in a subsequent processing step. By means of an optical check of this kind, it is furthermore possible to ensure the highest quality standards.

Further important features and advantages of the invention will become apparent from the dependent claims, from the drawings and from the associated description of the figures with reference to the drawings.

It is self-evident that the features mentioned above and those which will be explained below can be used not only in the respectively indicated combination but also in other combinations or in isolation without exceeding the scope of the present invention.

Preferred illustrative embodiments of the invention are shown in the drawings and are explained in greater detail in the following description, wherein identical reference signs refer to identical or similar or functionally identical components.

### BRIEF DESCRIPTION OF THE DRAWINGS

In the drawings, which are in each case schematic:

FIG. 1 shows a method according to the invention for applying an adhesive layer designed as an adhesive film to a strip material,

FIG. 2 shows an illustration like that in FIG. 1 but for a component designed as a tube,

FIG. 3 shows an alternative embodiment of the method according to the invention to that in FIG. 2,

FIG. 4 shows the application of liquid adhesive as an adhesive layer to a heat exchanger component designed as narrow stock,

FIG. 5 shows an illustration like that in FIG. 4 but with an extrusion unit,

FIG. 6 shows the spraying of an adhesive layer onto a component designed as a tube, using liquid adhesive,

FIG. 7 shows an illustration like that in FIG. 6 but with a different application unit,

FIG. 8 shows the application of adhesive designed as granules as an adhesive layer to a component designed as narrow stock,

FIG. 9 shows an illustration like that in FIG. 8 but with a component designed as a hot tube.

### DETAILED DESCRIPTION

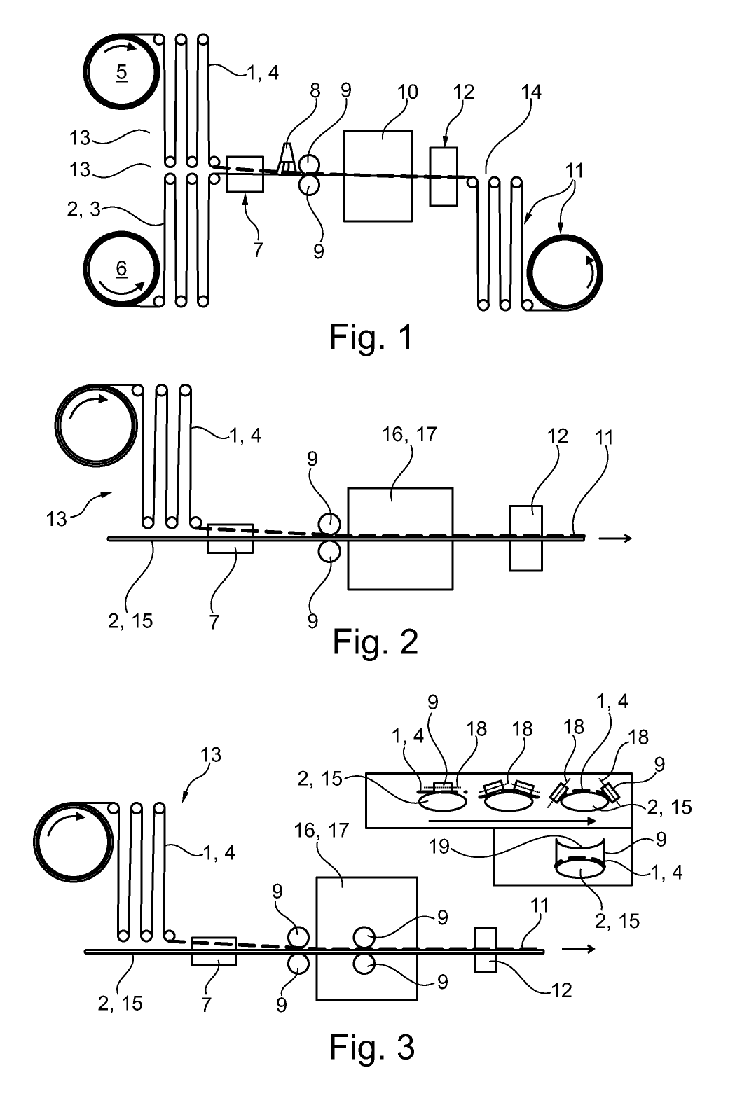

Alternative methods for applying an adhesive layer 1 to a heat exchanger component 2 to be coated (heat exchanger not shown) are shown in each of FIGS. 1 to 9, wherein the adhesive layer 1 is in each case applied to an outer side of the component 2, irrespective of the individual method steps of the alternative methods.

Considering the method shown in FIG. 1, the component 2 to be coated is designed as narrow stock 3 and the adhesive layer 1 is designed as adhesive film 4. Here, both the adhesive film 4 and the component 2 designed as narrow stock 3 are rolled up, namely, on the one hand, on an adhesive film roll 5 and, on the other hand, on a narrow stock roll 6. In a first method step, a surface of the narrow stock 3 to be coated with the adhesive layer 1 is then degreased and brushed, this taking place in a cleaning unit 7. In this case, degreasing and brushing can be performed by plasma or corona discharge or the like, for example. The adhesive film 4 is then heated by means of a heating unit 8, wherein the heating unit 8 can be designed as an infrared radiator or as an electric heating unit, for example. Once the adhesive film 4 has been heated, it is passed through pressure rollers 9 together with the narrow stock 3 to be coated and, during this process, they are pressed against one another. The coated narrow stock 3, i.e. the fully coated component, can then be cooled in a defined manner in a cooling unit 10, thereby enabling the coated component 11 to be rolled up more quickly. Before the fully coated components 11 is rolled up, it usually passes through an optical checking unit 12, in which discoloration, bubbles etc. are detected by means of an optical sensor. Arranged ahead of the cleaning unit 7 and after the optical checking unit 12 there are respective buffers, namely an initial buffer 13 and a final buffer 14. The narrow stock 3 can be an aluminum sheet, for example, which makes the narrow stock 3 not only well-suited to storage but also easy to process. By means of the method according to the invention, it is thus possible to apply the adhesive layer 1, by means of which a plurality of coated components 11 are subsequently adhesively bonded to one another and to form a heat exchanger, in a reliable process, continuously, with high-quality and, at the same time, at low cost. Moreover, the method according to the invention makes it possible to at least reduce, and preferably even to avoid, the risk of a nonuniform thickness of the adhesive layer 1.

Considering FIG. 2, it is possible to see there a method in which the component 2 to be coated is designed as a tube 15 and the adhesive layer 1 is designed as an adhesive film 4, just as in FIG. 1. In this method too, a surface of the tube 15 to be coated with the adhesive layer 1 is preferably first of all degreased and brushed, more specifically in the cleaning station 7. The adhesive film 4 and the tube 15 to be coated are then pressed against one another by pressure rollers 9, wherein the adhesive film 4 and the tube 15 to be coated are heated in the subsequent heating unit 16, e.g. a furnace 17, and, during this process, the adhesive film 4 is shrunk onto the tube 15 to be coated. After exit from the heating unit 16 or furnace 17, the coated component 11 once again passes through an optical checking unit 12 for quality assurance. Purely theoretically, it is also conceivable here for the tube 15 to be coated to be heated not only from the outside by the heating unit 16 or furnace 17 but also from the inside, e.g. by a hot air flow passed through the interior of the tube.

If the component 2, i.e. the tube 15, is produced by extrusion, for example, the heat of the tube 15 which arises during this process can also be used to shrink on the adhesive layer 1 or adhesive film 4. Here, the adhesive film 4 is likewise rolled up on an adhesive film roll 5 and, as a result, is easy to handle and easy to store. Considering the method according to the invention shown in FIG. 3, this differs from the method illustrated in FIG. 2 in that a plurality of pressure rollers 9 or pressure roller pairs arranged in series is provided, the axes 8 of which rollers are designed are aligned in such a way that they enable the adhesive film 4 to be pressed against the outer contour of the tube 15 to be coated and to hug said outer contour in a bubble-free manner. As an alternative, it is also conceivable for at least one pressure roller 9 to have a contour 19 matched to the outer contour of the component 2 to be coated, in this case the tube 15 to be coated, and, as a result, likewise to enable bubble-free and reliable application of the plastic film 4 to the tube 15 to be coated. Here, one of these pressure rollers 9 can furthermore be heatable, thereby making it possible to achieve an even better application and fixing process. By means of pressure rollers 9 designed and aligned in this way, the risk of defects can be considerably reduced and, as a result, production quality can be considerably enhanced. Moreover, processing of tubes 15 of different diameters or tube geometries is also conceivable simply by swapping the pressure rollers 9 or by spring mounting different pressure roller pairs.

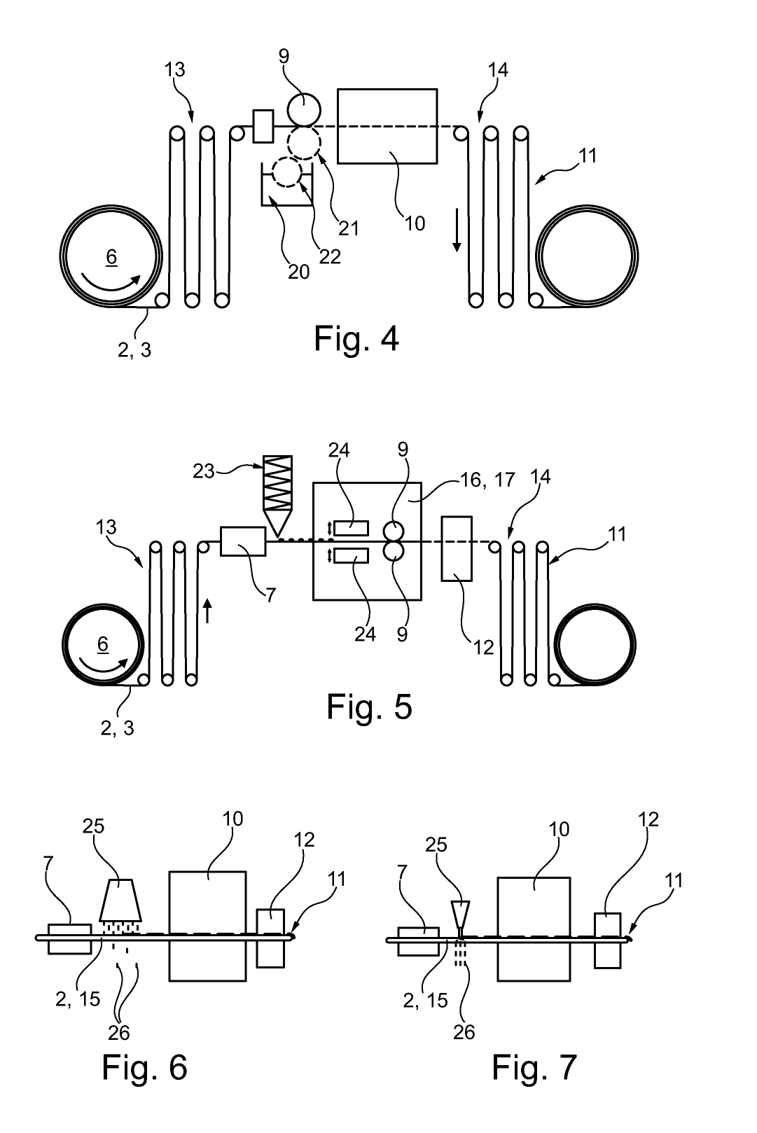

In the method shown in FIG. 4, the component 2 to be coated is designed as narrow stock 3 and the adhesive layer is designed as an initially liquid adhesive 20. Here, a surface of the narrow stock 3 to be coated with the adhesive layer 1 is preferably once again first of all degreased and brushed in the cleaning station 7, whereupon the still-liquid adhesive 20 is then applied by means of an application roller 21 to the narrow stock 3 to be coated. Transfer of the liquid adhesive 20 to the application roller 21 is accomplished by means of a transfer roller 22, for example. Once the adhesive layer 1 or liquid adhesive 20 has been applied by means of the application roller 21 to the previously degreased and brushed surface of the narrow stock 3 to be coated, the now coated component 11 once again passes through a cooling unit 10, in which the adhesive layer 1 is firmly fixed on the narrow stock 3. The advantage of a liquid adhesive 20 of this kind is, in particular, the fact that it can initially be supplied as granules and can be melted as required. By this means too, a continuous application process is possible.

In the methods illustrated in FIG. 5, the liquid adhesive 20 is applied by means of an extrusion unit 23, either continuously or, as illustrated, spotwise, wherein the adhesive layer 1 and the component 2 designed as narrow stock 3 are then heated and joined together by pressure rollers 9 or pressure plates 24. The now coated narrow stock 3, i.e. the fully coated component 11, is then likewise rolled up again. By means of the pressure rollers 9 or pressure plates 24, particularly uniform distribution of the adhesive layer 1 on the narrow stock 3 can be achieved.

Considering the methods shown in FIGS. 6 and 7, these differ only in having a different application unit 25, by means of which the liquid adhesive 20 can be applied to the tube 15 to be coated, e.g. spotwise or as a continuous strip of adhesive. After coating, the coated tube 15 once again passes through a cooling unit 10 and an optical checking unit 12, wherein the adhesive layer 1 is fixed on the tube 15 in the cooling unit 10, and the quality of the application process is checked in the checking unit 12.

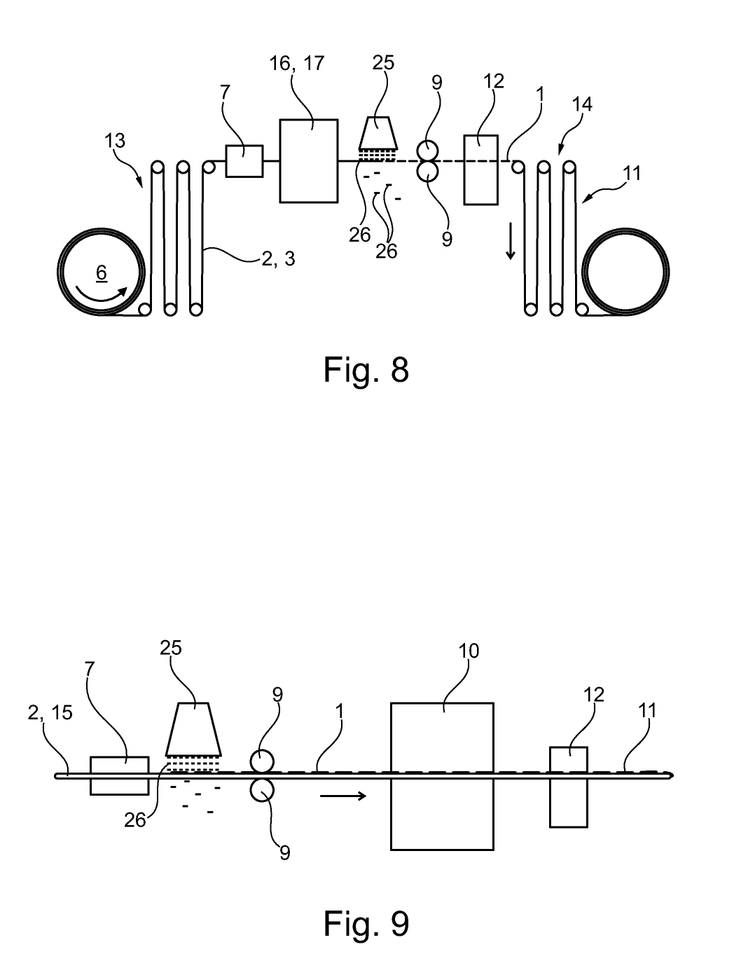

Considering now the alternatives of the method according to the invention shown in FIGS. 8 and 9, it can be seen there that, according to FIG. 8, the component 2 to be coated is designed as narrow stock 3 and, according to FIG. 9, as a tube 15. The adhesive layer 1 is initially designed as adhesive granules 26 or, more generally, as granules 26. In both methods, the surface of the component 2 to be coated, i.e. the narrow stock 3 to be coated or the tube 15 to be coated, is once again preferably first of all degreased and brushed in the cleaning unit 7. In respect of the further procedure, however, the two methods are different.

According to FIG. 8, the narrow stock 3 to be coated is then heated, and the granules 26 are then scattered onto said narrow stock, as a result of which they melt to form the adhesive layer 1 and occupy the surface to be coated of the narrow material 3. The coated narrow stock 3 is then passed with the applied adhesive layer 1 through pressure rollers 9 and, during this process, the adhesive layer 1 is rendered uniform and additionally joined to the narrow stock 3. In the method shown in FIG. 9, in contrast, the tube 15 to be coated is heated and the adhesive granules 26 are scattered onto the hot tube 15. Here too, the following pressure rollers bring about greater uniformity and better bonding of the adhesive layer 1 to the tube 15. The coated component 11, i.e. the tube 15 covered with the adhesive layer 1, is then cooled in the cooling unit 10 and checked in the optical checking unit 12 for any defects, bubbles etc.

Common to all the alternatives of the method according to the invention which are shown is the fact that the application of the adhesive layer 1 to the component 2 is possible in a reliable process, continuously, in a manner which saves resources and furthermore at low cost and, at the same time, a very high quality standard in respect of the application quality can be achieved. Corrugated fins or other component parts of a heat exchanger can be formed or stamped from the coated component 11, for example. It is likewise possible to install the coated tubes 15 in a heat exchanger of this kind.

1. A method for producing a heat exchanger, comprising adhesively bonding at least two components to one another by applying an adhesive layer to an outer side of at least one component of the at least two components.

2. The method as claimed in claim 1, wherein the at least one component to be coated is structured as a narrow stock and the adhesive layer is an adhesive film, further including:
heating the adhesive film;
passing the adhesive film and the narrow stock through a plurality of pressure rollers after heating the adhesive film and pressing the adhesive film and the narrow stock against one another while being passed through the plurality of pressure rollers to form a coated narrow stock; and
cooling and rolling up the coated narrow stock.

3. The method as claimed in claim 1, wherein the at least one component to be coated is structured as a tube and the adhesive layer is an adhesive film, further including:
pressing the adhesive film and the tube against one another by a plurality of pressure rollers; and
passing the adhesive film and the tube through a furnace and heating the adhesive film and the tube to shrink the adhesive film onto the tube.

4. The method as claimed in claim 2, further comprising heating at least one pressure roller of the plurality of pressure rollers prior to passing the adhesive film and the narrow stock through the plurality of pressure rollers.

5. The method as claimed in claim 3, wherein at least one of:
pressing the adhesive film and the tube includes matching a contour of at least one pressure roller of the plurality of pressure rollers to an external contour of the tube; and
pressing the adhesive film and the tube against one another by the plurality of pressure rollers includes at least two pressure roller pairs arranged in series.

6. The method as claimed in claim 1, wherein the at least one component to be coated is structured as a narrow stock and the adhesive layer is a liquid adhesive;
wherein applying the adhesive layer includes applying the liquid adhesive to the narrow stock via an application roller; and
cooling and rolling up the narrow stock after applying the liquid adhesive.

7. The method as claimed in claim 1, wherein the at least one component to be coated is structured as a narrow stock and the adhesive layer is liquid adhesive;
wherein applying the adhesive layer includes applying the liquid adhesive to the narrow stock via an extrusion unit;
heating and joining the adhesive layer and the narrow stock to form a coated narrow stock via at least one of pressure rollers and pressure plates; and
rolling up the coated narrow stock.

8. The method as claimed in claim 1, wherein the at least one component to be coated is structured as a tube and the adhesive layer is a liquid adhesive;
wherein applying the adhesive layer includes applying the liquid adhesive to the tube to form the adhesive layer via an extrusion unit; and
cooling the adhesive layer and the tube after applying the liquid adhesive to the tube.

9. The method as claimed in claim 1, wherein the at least one component to be coated is structured as a narrow stock and the adhesive layer is adhesive granules; and
wherein applying the adhesive layer includes heating the narrow stock and scattering the adhesive granules onto the narrow stock while heating the narrow stock to melt the adhesive granules and form the adhesive layer;
passing the narrow stock with the adhesive layer applied thereto through pressure rollers to join the adhesive granules to the narrow stock to provide a coated narrow stock where the adhesive layer is rendered uniform; and
rolling up the coated narrow stock.

10. The method as claimed in claim 1, wherein the at least one component to be coated is structured as a tube and the adhesive layer is adhesive granules; and
wherein applying the adhesive layer includes heating the tube and scattering the adhesive granules onto the tube;
passing the tube with the adhesive granules applied thereto through pressure rollers to join the adhesive granules to the tube to provide a coated tube where the adhesive layer is rendered uniform; and
cooling the coated tube.

11. The method as claimed in claim 1, further comprising performing an optical check of the adhesive layer after applying the adhesive layer to the at least one component.

12. The method as claimed in claim 3, further comprising heating at least one pressure roller of the plurality of pressure rollers prior to passing the adhesive film and the tube through the plurality of pressure rollers.

13. The method as claimed in claim 4, wherein at least one of:
pressing the adhesive film and the narrow stock includes matching a contour of at least one pressure roller of the plurality of pressure rollers to an external contour of the narrow stock; and
pressing the adhesive film and the narrow stock against one another by the plurality of pressure rollers includes at least two pressure roller pairs arranged in series.

14. The method as claimed in claim 12, wherein one of:
pressing the adhesive film and the tube includes matching a contour of at least one pressure roller of the plurality of pressure rollers to an external contour of the tube; and
pressing the adhesive film and the tube against one another by the plurality of pressure rollers includes at least two pressure roller pairs arranged in series.

15. The method as claimed in claim 2, further comprising performing an optical check of the adhesive layer after applying the adhesive layer to the at least one component.

16. The method as claimed in claim 3, further comprising performing an optical check of the adhesive layer after applying the adhesive layer to the at least one component.

17. A method for producing a heat exchanger, comprising:
adhesively bonding at least two components to one another, at least one component of the two components structured as a narrow stock;
heating an adhesive film;
heating at least one pressure roller of a plurality of pressure rollers;
pressing the heated adhesive film against an outer side of the narrow stock by passing the heated adhesive film and the narrow stock through the plurality of pressure rollers including the at least one heated pressure roller to form a coated narrow stock including an adhesive layer;
cooling and rolling up the coated narrow stock; and
performing an optical check of the adhesive layer.

18. The method as claimed in claim 17, wherein one of:
pressing the adhesive film and the narrow stock includes matching a contour of at least one pressure roller of the plurality of pressure rollers to an external contour of the narrow stock; and
pressing the adhesive film and the narrow stock against one another by the plurality of pressure rollers includes at least two pressure roller pairs arranged in series.

19. A method for producing a heat exchanger, comprising:
adhesively bonding at least two components to one another, at least one component of the two components structured as a tube;
heating at least one pressure roller of a plurality of pressure rollers;
pressing the adhesive film against an outer side of the tube via the plurality of pressure rollers including the at least one heated pressure roller;
shrinking the adhesive film onto the tube to form an adhesive layer on the tube by heating the adhesive film and the tube via passing the adhesive film and the tube through a furnace; and
performing an optical check of the adhesive layer.

20. The method as claimed in claim 19, wherein one of:
pressing the adhesive film and the tube includes matching a contour of at least one pressure roller of the plurality of pressure rollers to an external contour of the tube; and
pressing the adhesive film and the tube against one another by the plurality of pressure rollers includes at least two pressure roller pairs arranged in series.
